(19) United States
(12) Patent Application Publication
(10) Pub. No.: US 2024/0095525 A1
(43) Pub. Date: Mar. 21, 2024

(54) BUILDING AN EXPLAINABLE MACHINE LEARNING MODEL

(71) Applicant: Telefonaktiebolaget LM Ericsson (publ), Stockholm (SE)

(72) Inventors: Perepu SATHEESH KUMAR, Chennai (IN); M SARAVANAN, Chennai (IN); Sai Hareesh ANAMANDRA, BANGALORE KARNATAKA (IN)

(73) Assignee: Telefonaktiebolaget LM Ericsson (publ), Stockholm (SE)

(21) Appl. No.: 18/276,016

(22) PCT Filed: Feb. 4, 2021
(86) PCT No.: PCT/IN2021/050116

§ 371 Date: Aug. 4, 2023

(51) Int. Cl. G06N 3/08

(52) U.S. Cl. CPC G06N 3/08

(57) ABSTRACT

A computer-implemented method for building a machine learning (ML) model is provided. The method includes training a ML model using a set of input data, wherein the ML model includes a plurality of layers and each layer includes a plurality of filters, and wherein the set of input data includes class labels; obtaining a set of output data from training the ML model, wherein the set of output data includes class probabilities values; determining, for each layer in the ML model, by using the class labels and the class probabilities values, a working value for each filter in the layer; determining, for each layer in the ML model, a dominant filter, wherein the dominant filter is determined based on whether the working value for the filter exceeds a threshold; and building a subset ML model based on each dominant filter for each layer, wherein the subset ML model is a subset of the ML model.

### TECHNICAL FIELD

Disclosed are embodiments related to building an explainable machine learning (ML) model, and in particular, improving the explainability of ML models, such as, deep learning models.

### BACKGROUND

The vision of the Internet of Things (IoT) is to transform traditional objects to being smart objects by exploiting a wide range of advanced technologies, from embedded devices and communication technologies to Internet protocols, data analytics, and so forth. The potential economic impact of IoT is expected to bring many business opportunities and to accelerate the economic growth of IoT-based services. Based on a McKinsey's report for the economic impact of IoT by 2025, the annual economic impact of IoT is expected to be in the range of $2.7 trillion to $6.2 trillion. Healthcare constitutes the major part (about 41% of this market), followed by industry and energy (about 33%) and the IoT market (about 7%).

The communication industry plays a crucial role in the development of other industries, with respect to IoT. For example, other domains such as transportation, agriculture, urban infrastructure, security, and retail have about 15% of the IoT market. These expectations imply the tremendous and steep growth of IoT services, their generating big data, and consequently their related market in the years ahead. The main element of most of these applications is an intelligent learning mechanism for prediction (including classification and regression), or for clustering. Among the many machine learning approaches, “deep learning” (DL) has been actively utilized in many IoT applications in recent years.

These two technologies (deep learning and IoT) are among the top three strategic technology trends for next few more years. The ultimate success of IoT depends on the execution of machine learning (and in particular deep learning) in that IoT applications which will depend on accurate and relevant predictions, which can for example lead to improved decision making.

Recently, artificial intelligence and machine learning (which is a subset of artificial intelligence) have enjoyed tremendous success with widespread IoT applications across different fields. Currently, applications of deep learning methods have garnered significant interest in different industries such as healthcare, telecommunications, e-commerce, and so on. Over the last few years, deep learning models inspired by the connectionist structure of the human brain, which learn representations of data at different levels of abstraction, have been shown to outperform traditional machine learning methods across various predictive modeling tasks. This has largely been attributed to their superior ability to discern features automatically via different representations of data, and their ability to conform to non-linearity, which is very common in real world data. Yet these models (i.e. deep learning models) have a major drawback in that they are among the least understandable and explainable of machine learning models. The method by which these models arrive at their decisions via their weights is still very abstract.

For instance, in the case of Convolutional Neural Networks (CNNs), which are a subclass of deep learning models, when an image in the form of a pixel array is passed through the layers of a CNN model, the lower level layers of the model discern what appears to be the edges or the basic discriminative features of the image. As one goes deeper into the CNN model's layers, the features extracted are more abstract and the model's working is less clear and less understandable to humans.

This lack of interpretability and explainability has fostered some reservations regarding machine learning models, despite their successes. Regardless of their successes, it is paramount that such models are trustworthy for them to be adopted at scale. This lack of explainability could hinder the adoption of such models in certain applications like medicine, telecommunication, and so on, where it is paramount to understand the decision-making process as the stakes are much higher. For an instance, a doctor is less likely to trust the decisions of a model if he is not clear about its approach, especially, if it were to conflict with his own decision. However, the problem with typical machine learning models is that they function as black-box models without offering explainable insights into their decision making process.

The explainability of deep learning models has become even more challenging as more and more layers are being used to train the models to achieve good accuracy output. For such DL models, the end-user does not have knowledge on what basis the model is giving predictions, and explaining the decision-making process is becoming increasingly more difficult.

In an effort to try to address these problems and explain how the model generated the predictions, explainable techniques, such as LIME and SHARP, have been used. See, e.g., Ribeiro, Marco Tulio, Sameer Singh, and Carlos Guestrin—“Why should I trust you? Explaining the predictions of any classifier,” in Proceedings of the 22nd ACM SIGKDD International Conference on Knowledge Discovery and Data Mining, pp. 1135-1144 (2016); and Szegedy, Christian, Wojciech Zaremba, Ilya Sutskever, Joan Bruna, Dumitru Erhan, Ian Goodfellow, and Rob Fergus—“Intriguing properties of neural networks,” arXiv preprint arXiv:1312.6199 (2013). However, these techniques are time consuming and can only generate explanations after trying all different combinations of the input features.

Another approach that is being used to try to address the explainability problem is knowledge distillation. See, e.g., Geoffrey Hinton, Oriol Vinyals, and Jeff Dean, “Distilling the Knowledge in a Neural Network”, arXiv:1503.02531 (2015). Knowledge distillation is the process of distilling the knowledge from one ML model, which can be referred to as the “teacher” model, to another ML model, which can be referred to as the “student” model. Usually, the teacher model is a complex DL model, such as, a multi-layer neural network with, for example, a 20-layer network. Complex models such as these require significant time and processing resources for training, such as, for example, using a graphics processing unit (GPU) or another device with similar processing resources. There is a desire for a ML model that behaves like the teacher model, but requires less time and less use of resources. This is the concept behind knowledge distillation.

There have been some efforts to apply knowledge distillation to explainability of ML models by distilling knowledge to an explainable student model. See, e.g., Zhang, Yuan, Xiaoran Xu, Hanning Zhou, and Yan Zhang—“Distilling structured knowledge into embeddings for explainable and accurate recommendation,” in Proceedings of the 13th International Conference on Web Search and Data Mining, pp. 735-743 (2020); and Cheng, Xu, Zhefan Rao, Yilan Chen, and Quanshi Zhang—“Explaining Knowledge Distillation by Quantifying the Knowledge,” in Proceedings of the IEEE/CVF Conference on Computer Vision and Pattern Recognition, pp. 12925-12935 (2020). The knowledge of the teacher model is distilled and transferred to the student model as a random forest model, which can be explained. However, none of these approaches addresses the problem with the explainability of the teacher model itself and, more specifically, how the predictions are generated.

### SUMMARY

Available methods for explainability of ML models, as discussed above, each have limitations and drawbacks and, most importantly, do not address the problem with the explainability of the teacher model itself and how the predictions are generated. Focusing again on the concept of knowledge distillation, as mentioned above, there is a desire for a ML model that behaves like the teacher model, but requires comparatively less computation time and less usage of resources.

FIG. 1 illustrates a distillation model 100 and the process of distilling the knowledge from one ML model (i.e., the “teacher” model) 110 to another distilled ML model (i.e., the “student” model) 120. As explained, the teacher model 110 is, typically, a complex DL model, such as, a multi-layer neural network with, for example, a 20-layer network. In order to keep the knowledge of the teacher model 110, the student model 120 can be trained on the predicted probabilities 130, for example the softmax probabilities, of the teacher model, and usually in less time and on a device having less powerful computational resources than for the original teacher model. By doing this, the knowledge of the teacher model can be transferred efficiently to the student model and the student model behaves like the teacher model.

The knowledge distillation process can also be applied in a layer-wise approach, distilling the knowledge from the teacher model to the student model for each layer (i.e., layer-wise). While this will ensure that the layer-wise features of the teacher model are captured, the distillation and transfer of the layer-wise features is complex, time-consuming and inefficient, and require optimization to be practical and explainable. Embodiments provided herein address this optimization problem, providing methods for ensuring that layer-wise features of the teacher model are captured in an efficient way, including, for example, by distilling the knowledge and identifying which features are important in the layer. One advantage of this is the efficient transfer of the knowledge of teacher model to the student model.

While this addresses the issue of efficiency, it does not provide for the desired explainability of the teacher model. The approach of distilling the knowledge of the student model from the teacher model onto the student model and, for example, using the student model as a decision tree model can provide for explainability of the student model. However, even in this case, in many situations, this process results in loss of information, which comes as a trade-off between the choice of relying on the architecture of the student model and computational time and resources.

Embodiments provided herein address this loss of information and alleviate the need to rely on the student model, by providing a method for building an explainable teacher model, referred to as a “subset” teacher model. The methods disclosed herein use the concept of knowledge distillation and, in contrast with other approaches, provide for an explainable ML model—i.e., the subset teacher model.

Embodiments provided herein are applicable to different ML and neural network architectures, including convolutional neural networks (CNN) and artificial neural networks (ANN). The term “filter” as used herein is intended to include and is used interchangeably with “neuron” and “neural nodes information” when the ML model architecture used is an ANN.

Embodiments provided herein provide further for the identification of which features are dominant and participating in the classification. The extraction of efficient filters (neurons) from deep learning models was addressed in application PCT/IN2019/050455. In accordance with the methods disclosed in that application, the extraction and identification of the dominant, best working filters (neurons) is based on the relating between the output of the filter and predictions being linear, and is a trial and error approach. It is possible, in the ML (teacher) model that the output of the filter is related in non-linear fashion to the predictions. The methods disclosed herein, in identifying which features are dominant and participating in the classification—i.e., best working filters (neurons)—, provide for the relating of the output of the filter and the predictions being non-linear, are do not require a trial and error approach, which can affect the computational complexity of the method.

The methods of the embodiments disclosed herein enable the efficient building of a subset teacher model, which represents the teacher model and is explainable. By using the identified subset of the filters in each layer, knowledge from the teacher model can be distilled efficiently. The novel methods disclosed herein result in lower inferencing time and substantial reduction in use of computational resources. In addition, the subset teacher model can be used for many purposes, including for explaining the predictions of the teacher model and for efficient distillation of the knowledge from teacher model to the student model.

One example provided herein to demonstrate use of the subset ML model built according to the novel methods of the present embodiments is fault detection in telecommunication networks. Fault detection is a very important problem in network equipment. This includes detecting faults in advance so that preventive actions can be taken. Usually, to detect faults, pre-trained models are used, which are very complex, or complicated DL models are trained from data, in which the features and output are non-linearly related with each other. However, these models are not explainable, as they are very complex.

To enable customers to understand the predictions and how the models work, an explainable model is needed for determining the filters (neurons) that are dominant and participating in the classification and predictions—i.e., the best working filters (neurons)—are identified and can be explained to the customers.

Advantages of the embodiments include less inferencing time, as smaller subsets of the ML model are being used, and significantly enhanced explainability involving analysis of only some filters (neurons) instead of all the filters (neurons). Another advantage is that the subset ML model can be deployed in any low power edge device, and a network engineer/FSO can use this model and obtain meaningful predictions in, for example, a remote location.

According to a first aspect, a computer-implemented method for building a machine learning (ML) model is provided. The method includes training a ML model using a set of input data, wherein the ML model includes a plurality of layers and each layer includes a plurality of filters, and wherein the set of input data includes class labels; obtaining a set of output data from training the ML model, wherein the set of output data includes class probabilities values; determining, for each layer in the ML model, by using the class labels and the class probabilities values, a working value for each filter in the layer; determining, for each layer in the ML model, a dominant filter, wherein the dominant filter is determined based on whether the working value for the filter exceeds a threshold; and building a subset ML model based on each dominant filter for each layer, wherein the subset ML model is a subset of the ML model.

In some embodiments, the subset ML model is stored in a database. In some embodiments, the ML model is a teacher model and the subset ML model is a subset teacher model. In some embodiments, the ML model and the subset ML model are one of: a neural network, a convolutional neural network (CNN), and a artificial neural network (ANN). In some embodiments, the method includes using the subset teacher model as a student ML model.

In some embodiments, the subset ML model is used to detect faults in one or more network nodes in a network. In some embodiments, the subset ML model is used to detect faults in one or more wireless sensor devices in a network.

According to a second aspect, a node adapted for building a machine learning (ML) model is provided. The node includes a data storage system and a data processing apparatus comprising a processor, wherein the data processing apparatus is coupled to the data storage system. The data processing apparatus is configured to: train a ML model using a set of input data, wherein the ML model includes a plurality of layers and each layer includes a plurality of filters, and wherein the set of input data includes class labels; obtain a set of output data from training the ML model, wherein the set of output data includes class probabilities values; determine, for each layer in the ML model, by using the class labels and the class probabilities values, a working value for each filter in the layer; determine, for each layer in the ML model, a dominant filter, wherein the dominant filter is determined based on whether the working value for the filter exceeds a threshold; and build a subset ML model based on each dominant filter for each layer, wherein the subset ML model is a subset of the ML model.

According to a third aspect, a node is provided. The node includes a training unit configured to train a ML model using a set of input data, wherein the ML model includes a plurality of layers and each layer includes a plurality of filters, and wherein the set of input data includes class labels; an obtaining unit configured to obtain a set of output data from training the ML model, wherein the set of output data includes class probabilities values; a first determining unit configured to determine, for each layer in the ML model, by using the class labels and the class probabilities values, a working value for each filter in the layer; a second determining unit configured to determine, for each layer in the ML model, a dominant filter, wherein the dominant filter is determined based on whether the working value for the filter exceeds a threshold; and a building unit configured to build a subset ML model based on each dominant filter for each layer, wherein the subset ML model is a subset of the ML model.

According to a fourth aspect, a computer program is provided. The computer program includes instructions which when executed by processing circuitry of a node causes the node to perform the method of any one of the embodiments of the first aspect.

According to a fifth aspect, a carrier is provided. The carrier contains the computer program of the fourth aspect, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a distillation model.

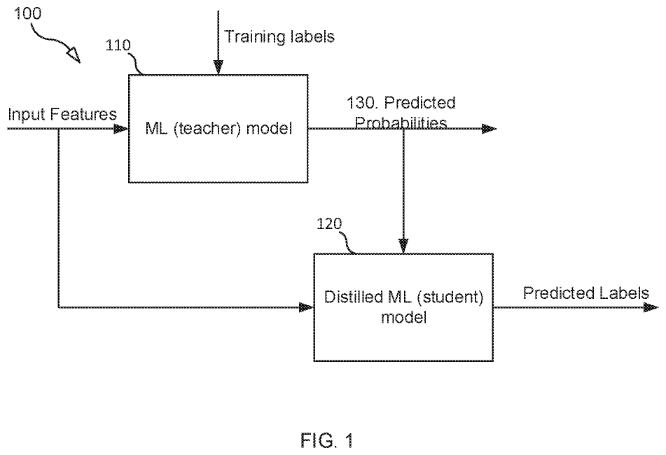

FIG. 2 illustrates a block diagram according to an embodiment.

FIG. 3 illustrates a message sequence diagram according to an embodiment.

FIG. 4 illustrates a flow chart according to an embodiment

FIG. 5 is a block diagram illustrating an apparatus, according to an embodiment, for performing steps disclosed herein.

FIG. 6 is a block diagram illustrating an apparatus, according to an embodiment, for performing steps disclosed herein.

### DETAILED DESCRIPTION

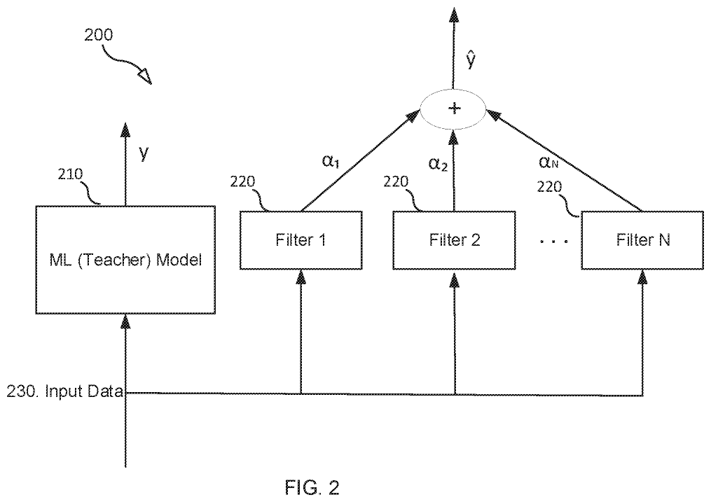

FIG. 2 illustrates a block diagram according to an embodiment. As shown, the block diagram 200 includes an ML (Teacher) Model block 210 and Filter blocks 1, 2, . . . N 220. In some embodiments, the ML (teacher) model 210 may be a convolutional neural network (CNN) model including a plurality of layers, with each layer including a plurality of filters. The ML (teacher) model may be an artificial neural network (ANN), in which case the filters 220 would be neurons.

Input data 230, which includes class labels, is used to train the ML (teacher) model 210. A set of output data including class probabilities values y is obtained from training the ML (teacher) model 210. All of the filters 220, which are retrained in this process as explained further, are collected and a determination of which of these filters participated more in classification, and with respect to each sample—i.e., class label—information on what are the features that participated in the classification, are identified. The filters in each layer are collected, an optimization problem is solved, and the coefficients α are computed.

With reference again to FIG. 2, the input data 230 including the class labels, and the output data including the class probabilities values are used, for each layer in the ML (teacher) model 210, with filters 1, 2, . . . N 220 to determine a working value α₁ . . . N for each filter 220 in the layer. The layer-wise working value for each filter in the layer is determined according to:

$${\sum }_{{α}^{i = 1 , … , N}}^{min} {α}_{i} {f}_{i} - \hat{y}$$

where:
fᵢ represents the output of each filter based on training using the set of input data; and
ŷ represents the class probabilities values from the obtained set of output data.

A dominant filter for each layer in the ML (teacher) model 210 is determined according to:

$${\sum }_{{α}^{i = 1 , … , N}}^{min} {α}_{i} {f}_{i} - \hat{y} + γ {‖ α ‖}_{1}$$

where:
fᵢ represents the output of each filter based on training using the set of input data; and
ŷ represents the class probabilities values from the obtained set of output data.

In the above equations, the y is the model scores obtained for each label of the data and is used to compute coefficients α. A regularization term—∥α∥₁—ensures the coefficients are sparse and only the dominant—i.e., best working—filter per layer is determined. Now, the above equations are solved for each layer and the dominant—i.e., best working—filter in every layer is identified. The dominant filter is determined based on whether the working value for the filter exceeds a threshold.

With the dominant filter for each layer determined, the explainable ML (subset teacher) model is built. The output of each layer's dominant filter for the specific class labels in the set of input data is collected. For each class label, features in the data which the filter classified are identified, and using this identified information, the data is searched for features in the data which may be classified as such class label. This enables identification of the set of features which are responsible for that class label.

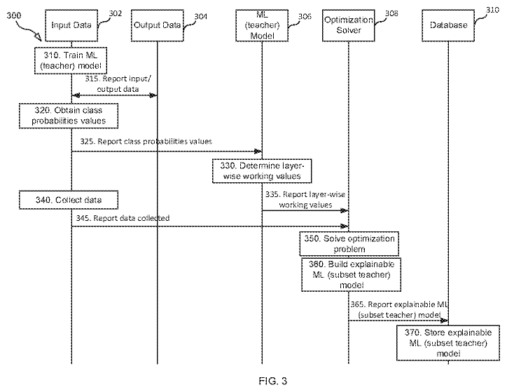

FIG. 3 illustrates a message sequence diagram 300 according to an embodiment. As shown, Input Data 302, Output Data 304, an ML (teacher) Model 306, an Optimization Solver 308, and a Database 310 interact in the disclosed methods for building an explainable ML (subset teacher) model. At 310, the ML (teacher) Model is trained using Input Data 302 and Output Data 304, which, at 315, is reported. At 320, class probabilities values are obtained and, at 325, are reported to the ML (teacher) Model 306. At 330, layer-wise working values are determined, and at 335, are reported to Optimization Solver 308. At 340, data—the input data, which includes class labels, and the output data, which includes the class probabilities values—is collected, and at 345, is reported to the Optimization Solver 308. At 350, the optimization problem is solved by determining, for each layer in the ML (teacher) model, a dominant filter, which is determined based on whether the layer-wise working value for the filter exceeds a threshold. At 360, the explainable ML (subset teacher) model is built based on each dominant filter for each layer. The explainable ML (subset teacher) model is reported, at 365, to Database 310. At 370, the explainable ML (subset teacher) model is stored in Database 310.

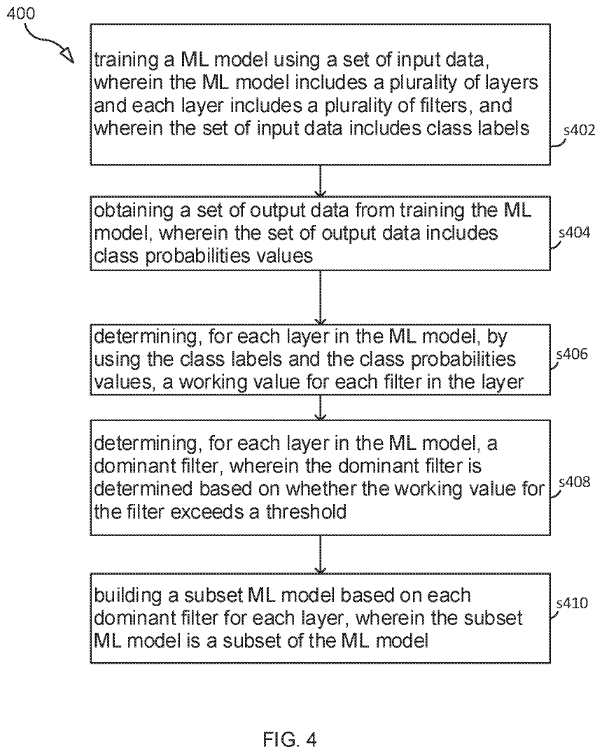

FIG. 4 is a flowchart illustrating a process 400 according to some embodiments. Process 400 may begin with step s402.

Step s402 comprises training a ML model using a set of input data, wherein the ML model includes a plurality of layers and each layer includes a plurality of filters, and wherein the set of input data includes class labels.

Step s404 comprises obtaining a set of output data from training the ML model, wherein the set of output data includes class probabilities values.

Step s406 comprises determining, for each layer in the ML model, by using the class labels and the class probabilities values, a working value for each filter in the layer.

Step s408 comprises determining, for each layer in the ML model, a dominant filter, wherein the dominant filter is determined based on whether the working value for the filter exceeds a threshold.

Step s410 comprises building a subset ML model based on each dominant filter for each layer, wherein the subset ML model is a subset of the ML model.

In some embodiments, the subset of the ML model is stored in a database. In some embodiments, the ML model is a teacher model and the subset ML model is a subset teacher model. In some embodiments, the ML model and the subset ML model are one of: a neural network, a convolutional neural network (CNN), and a artificial neural network (ANN). In some embodiments, the method includes using the subset teacher model as a student ML model.

Exemplary embodiments provided herein demonstrate use of the subset ML model built according to the novel methods of the present embodiments for fault detection in telecommunication networks. Fault detection is a very important problem in network equipment. This includes detecting faults in advance so that preventive actions can be taken. Usually, to detect faults, pre-trained models are used, which are very complex, or complicated DL models are trained from data, in which the features and output are non-linearly related with each other. However, these models are not explainable, as they are very complex. In some embodiments, the subset ML model is used to detect faults in one or more network nodes in a network. In some embodiments, the subset ML model is used to detect faults in one or more wireless sensor devices in a network.

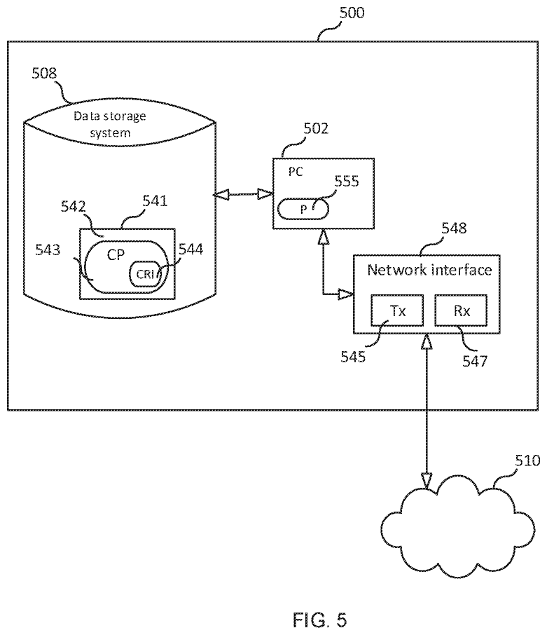

FIG. 5 is a block diagram of an apparatus 500, according to some embodiments. Apparatus 500 may be a network node, such as a base station, a computer, a server, a wireless sensor device, or any other unit capable of implementing the embodiments disclosed herein. As shown in FIG. 5, apparatus 500 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors 555 may be co-located in a single housing or in a single data center or may be geographically distributed (i.e., apparatus 500 may be a distributed apparatus); a network interface 548 comprising a transmitter (Tx) 545 and a receiver (Rx) 547 for enabling apparatus 500 to transmit data to and receive data from other nodes connected to network 510 (e.g., an Internet Protocol (IP) network) to which network interface 548 is connected; and a local storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes apparatus 500 to perform steps described herein (e.g., steps described herein with reference to the flow charts). In other embodiments, apparatus 500 may be configured to perform steps described herein without the need for code. That is, for example, PC 502 may consist merely of one or more ASICs. Hence, the features of the embodiments described herein may be implemented in hardware and/or software.

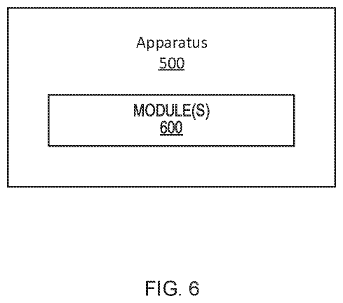

FIG. 6 is a schematic block diagram of the apparatus 500 according to some other embodiments. The apparatus 500 includes one or more modules 600, each of which is implemented in software. The module(s) 600 provide the functionality of apparatus 500 described herein and, in particular, the functionality of a network node (e.g., the steps herein, e.g., with respect to FIG. 4).

In some embodiments, the modules 600 may include a training unit configured to train a ML model using a set of input data, wherein the ML model includes a plurality of layers and each layer includes a plurality of filters, and wherein the set of input data includes class labels; an obtaining unit configured to obtain a set of output data from training the ML model, wherein the set of output data includes class probabilities values; a first determining unit configured to determine, for each layer in the ML model, by using the class labels and the class probabilities values, a working value for each filter in the layer; a second determining unit configured to determine, for each layer in the ML model, a dominant filter, wherein the dominant filter is determined based on whether the working value for the filter exceeds a threshold; and a building unit configured to build a subset ML model based on each dominant filter for each layer, wherein the subset ML model is a subset of the ML model.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer-implemented method for building a machine learning (ML) model, the method comprising:
training a ML model using a set of input data, wherein the ML model includes a plurality of layers and each layer includes a plurality of filters, and wherein the set of input data includes class labels;
obtaining a set of output data from training the ML model, wherein the set of output data includes class probabilities values;
determining, for each layer in the ML model, by using the class labels and the class probabilities values, a working value for each filter in the layer;
determining, for each layer in the ML model, a dominant filter, wherein the dominant filter is determined based on whether the working value for the filter exceeds a threshold; and
building a subset ML model based on each dominant filter for each layer, wherein the subset ML model is a subset of the ML model.

2. The method according to claim 1, further comprising:
storing the subset ML model in a database.

3. The method according to claim 1, wherein the ML model is a teacher model and the subset ML model is a subset teacher model.

4. The method according to claim 1, wherein the ML model and the subset ML model are one of: a neural network, a convolutional neural network (CNN), and a artificial neural network (ANN).

5. The method according to claim 1, wherein the working value for each filter in the layer is determined according to:
$${\sum }_{{α}^{i = 1 , … , N}}^{min} {α}_{i} {f}_{i} - \hat{y}$$
where:
fᵢ represents the output of each filter based on training using the set of input data; and
ŷ represents the class probabilities values from the obtained set of output data.

6. The method according to claim 1, wherein the dominant filter for each layer is determined according to:
$${\sum }_{{α}^{i = 1 , … , N}}^{min} {α}_{i} {f}_{i} - \hat{y} + γ {‖ α ‖}_{1}$$
where:
fᵢ represents the output of each filter based on training using the set of input data; and
ŷ represents the class probabilities values from the obtained set of output data.

7. The method according to claim 3, wherein the subset teacher model is used as a student ML model.

8. The method according to claim 1, further comprising:
using the subset ML model to detect faults in one or more network nodes in a network.

9. The method according to claim 1, further comprising:
using the subset ML model to detect faults in one or more wireless sensor devices in a network.

10. A node adapted for building a machine learning (ML) model, the node comprising:
a data storage system; and
a data processing apparatus comprising a processor, wherein the data processing apparatus is coupled to the data storage system, and the data processing apparatus is configured to:
train a ML model using a set of input data, wherein the ML model includes a plurality of layers and each layer includes a plurality of filters, and wherein the set of input data includes class labels;
obtain a set of output data from training the ML model, wherein the set of output data includes class probabilities values;
determine, for each layer in the ML model, by using the class labels and the class probabilities values, a working value for each filter in the layer;
determine, for each layer in the ML model, a dominant filter, wherein the dominant filter is determined based on whether the working value for the filter exceeds a threshold; and
build a subset ML model based on each dominant filter for each layer, wherein the subset ML model is a subset of the ML model.

11. The node according to claim 10, wherein the data processing apparatus is further configured to:
store the subset ML model in a database.

12. The node according to claim 10, wherein the ML model is a teacher model and the subset ML model is a subset teacher model.

13. The node according to claim 10, wherein the ML model and the subset ML model are one of: a neural network, a convolutional neural network (CNN), and a artificial neural network (ANN).

14. The node according to claim 10, wherein the working value for each filter in the layer is determined according to:
$${\sum }_{{α}^{i = 1 , … , N}}^{min} {α}_{i} {f}_{i} - \hat{y}$$
where:
fᵢ represents the output of each filter based on training using the set of input data; and
ŷ represents the class probabilities values from the obtained set of output data.

15. The node according to claim 10, wherein the dominant filter for each layer is determined according to:
$${\sum }_{{α}^{i = 1 , … , N}}^{min} {α}_{i} {f}_{i} - \hat{y} + γ {‖ α ‖}_{1}$$
where:
fᵢ represents the output of each filter based on training using the set of input data; and
ŷ represents the class probabilities values from the obtained set of output data.

16. The node according to claim 12, wherein the subset teacher model is used as a student ML model.

17. The node according to claim 10, wherein the data processing apparatus is further configured to:
use the subset ML model to detect faults in one or more network nodes in a network.

18. The node according to claim 10, wherein the data processing apparatus is further configured to:
use the subset ML model to detect faults in one or more wireless sensor devices in a network.

19. A node adapted for building a machine learning (ML) model, the node comprising:
a training unit configured to train a ML model using a set of input data, wherein the ML model includes a plurality of layers and each layer includes a plurality of filters, and wherein the set of input data includes class labels;
an obtaining unit configured to obtain a set of output data from training the ML model, wherein the set of output data includes class probabilities values;
a first determining unit configured to determine, for each layer in the ML model, by using the class labels and the class probabilities values, a working value for each filter in the layer;
a second determining unit configured to determine, for each layer in the ML model, a dominant filter, wherein the dominant filter is determined based on whether the working value for the filter exceeds a threshold; and
a building unit configured to build a subset ML model based on each dominant filter for each layer, wherein the subset ML model is a subset of the ML model.

20. A computer program product comprising a non-transitory computer readable medium storing instructions which, when executed by processing circuitry of a node causes the node to perform the method according to claim 1.

21. (canceled)
